(19) United States
(12) Patent Application Publication
(10) Pub. No.: US 2023/0025940 A1
(43) Pub. Date: Jan. 26, 2023

(54) APPARATUS FOR ESTIMATING OBSTACLE SHAPE AND METHOD THEREOF

(71) Applicants: Hyundai Motor Company, Seoul (KR); Kia Corporation, Seoul (KR)

(72) Inventor: Dong Hun Yang, Anyang-Si (KR)

(73) Assignees: Hyundai Motor Company, Seoul (KR); Kia Corporation, Seoul (KR)

(21) Appl. No.: 17/706,212

(22) Filed: Mar. 28, 2022

(30) Foreign Application Priority Data
Jul. 26, 2021 (KR) 10-2021-0098046

(51) Int. Cl. G01S 15/931; G01B 15/04

(52) U.S. Cl. CPC G01S 15/931; G01B 15/04

(57) ABSTRACT

An obstacle shape estimating apparatus and a method thereof, includes: a processor configured to receive a the sensing signal from at least one ultrasonic sensor at a predetermined cycle, to generate positions of one or more obstacles according to distance values of an ultrasonic sensor by estimating the distance values of the ultrasonic sensor based on a sensing signal, and to generate obstacle shape information according to positions of remaining obstacles after deleting a position of an obstacle corresponding to a virtual distance value and a position of an obstacle which does not satisfy a validation condition among the positions of the one or more obstacles; and a storage configured to store data and an algorithm driven by the processor, and the obstacle shape information generated by the processor.

### CROSS-REFERENCE TO RELATED APPLICATION

The present application claims priority to Korean Patent Application No. 10-2021-0098046, filed on Jul. 26, 2021, the entire contents of which is incorporated herein for all purposes by this reference.

### BACKGROUND OF THE INVENTION

### Field of the Invention

The present invention relates to an obstacle shape estimating apparatus and a method thereof, and more particularly, to an obstacle shape estimating technique based on an ultrasonic sensor, for preventing parking collision.

### Description of Related Art

In general, a smart parking assist system (SPAS) developed to assist in estimating the shape of an obstacle generates a parking trajectory based on information collected by use of various sensors and places a vehicle in a desired space while following the parking trajectory.

This SPAS utilizes a plurality of ultrasonic sensors provided in the vehicle in detecting obstacles in the parking trajectory, and in the instant case, positions of the obstacles are estimated by a combination of previous ultrasonic sensor signals, and when a speed of the host vehicle is high, accuracy may be reduced compared to a low speed.

In addition generally, an intersection point is generated in an ellipse which may be generated by use of one received pair of ultrasonic sensor signal information, and thus position information related to a large obstacle is generated close. A number, a size, a position, etc. of obstacles (single/plural) vary depending on a situation, but it is difficult to estimate precise positions or shapes of the obstacles even using time delay curves or an intersection method.

The information disclosed in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing an obstacle shape estimating apparatus and a method thereof, configured for accurately estimating a shape of an obstacle regardless of a vehicle speed and a number, a size, a position of a vehicle, etc. by removing an undetected area from an area which is detected for each ultrasonic sensor which is received in real time.

Furthermore, various aspects of the present invention are directed to providing an obstacle shape estimating apparatus and a method thereof, configured for improving accuracy of obstacle shape estimation by generating a virtual ultrasonic sensor signal and using it to estimate a shape of an obstacle when a distance between two provided ultrasonic sensors is more than a predetermined distance (for a large vehicle).

The technical objects of the present invention are not limited to the objects mentioned above, and other technical objects not mentioned may be clearly understood by those skilled in the art from the description of the claims.

Various aspects of the present invention are directed to providing an obstacle shape estimating apparatus including: a processor configured to receive a the sensing signal from at least one ultrasonic sensor at a predetermined cycle, to generate positions of one or more obstacles according to distance values of an ultrasonic sensor by estimating the distance values of the ultrasonic sensor based on a sensing signal, and to generate obstacle shape information according to positions of remaining obstacles after deleting a position of an obstacle corresponding to a virtual distance value and a position of an obstacle which does not satisfy a validation condition among the positions of the one or more obstacles; and a storage configured to store data and an algorithm driven by the processor, and the obstacle shape information generated by the processor.

In various exemplary embodiments of the present invention, the processor may determine an obstacle outside a vehicle width among the positions of the one or more obstacles, and corrects the obstacle outside the vehicle width to an outside of the vehicle width.

In various exemplary embodiments of the present invention, the processor, when a number of the one or more obstacles is smaller than and equal to a predetermined number and positions of two adjacent obstacles among positions of the obstacles of which the number is smaller than and equal to the predetermined number are within a predetermined distance, may abbreviate the positions of the two adjacent obstacles to a position of one obstacle.

In various exemplary embodiments of the present invention, the processor may estimate distance values of the one or more ultrasonic sensors by reflecting a travel distance and a travel direction of a host vehicle within the predetermined cycle.

In various exemplary embodiments of the present invention, the processor may generate a virtual ultrasonic sensor between two adjacent ultrasonic sensors when a distance between the two adjacent ultrasonic sensors is equal to or greater than a predetermined distance.

In various exemplary embodiments of the present invention, the processor may estimate a virtual distance value of the virtual ultrasonic sensor by use of a distance value of an ultrasonic sensor adjacent to the virtual ultrasonic sensor among the one or more ultrasonic sensors.

In various exemplary embodiments of the present invention, the processor may perform ultrasonic sensor waveform modeling by use of at least one of a beam angle, a sensitivity, a mounting position, or an angle of the one or more ultrasonic sensors.

In various exemplary embodiments of the present invention, the processor may generate a start point, a midpoint, and an end point of an ultrasonic sensor waveform as obstacle positions based on the ultrasonic sensor waveform modeling.

In various exemplary embodiments of the present invention, the processor may delete a start point, a midpoint, and an end point of a virtual distance waveform based on the virtual distance value.

In various exemplary embodiments of the present invention, the processor may determine whether a triangle is formed by use of a distance between two adjacent ultrasonic sensors and distance values of the two adjacent ultrasonic sensors to determine whether the validation condition is satisfied.

In various exemplary embodiments of the present invention, the processor may delete a position of an obstacle outside a vehicle width from among the positions of the one or more obstacles.

In various exemplary embodiments of the present invention, the processor may delete a position of an obstacle which is more than a predetermined distance away from among the one or more obstacle positions.

In various exemplary embodiments of the present invention, the processor may delete the start point and the end point when there is the midpoint of the ultrasonic sensor waveform.

In various exemplary embodiments of the present invention, the processor may delete the start point and the end point when a predetermined number or more of obstacle positions are generated in a center portion of a bumper of a vehicle

In various exemplary embodiments of the present invention, the processor, when at least one of a bumper of a vehicle or one or more obstacle positions is positioned within a predetermined distance, deletes an obstacle position which is within the predetermined distance from the bumper of the vehicle, and may replace it with an obstacle proximity plug.

In various exemplary embodiments of the present invention, the processor may determine a possibility of collision by use of obstacle shape information.

Various aspects of the present invention are directed to providing an obstacle shape estimating method including: receiving a sensing signal from one or more ultrasonic sensors every predetermined cycle; estimating a distance value of an ultrasonic sensor based on the sensing signal; generating one or more obstacle positions based on the distance value of the ultrasonic sensor; deleting a position of an obstacle corresponding to a virtual distance value and a position of an obstacle which does not satisfy a validation condition among the positions of the one or more obstacles; and generating obstacle shape information according to positions of remaining obstacles after the deleting.

In various exemplary embodiments of the present invention, the estimating of the distance value of the ultrasonic sensor may include estimating distance values of the one or more ultrasonic sensors by reflecting a travel distance and a travel direction of a host vehicle within the predetermined cycle.

In various exemplary embodiments of the present invention, the deleting of the positions of the obstacles, when a number of the one or more obstacles is smaller than and equal to a predetermined number and positions of two adjacent obstacles among positions of the obstacles of which the number is smaller than and equal to the predetermined number are within a predetermined distance, may include abbreviating the positions of the two adjacent obstacles to a position of one obstacle.

In various exemplary embodiments of the present invention, it may further include generating a virtual ultrasonic sensor between two adjacent ultrasonic sensors when a distance between the two adjacent ultrasonic sensors is equal to or greater than a predetermined distance.

According to the present technique, it is possible to accurately estimate a shape of an obstacle regardless of vehicle type (vehicle size), a vehicle speed and a number, a size, a position of a vehicle, etc.

Furthermore, various effects that can be directly or indirectly identified through the present specification may be provided.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a block diagram showing a configuration of a vehicle system including an obstacle shape estimating apparatus according to various exemplary embodiments of the present invention.

FIG. 2A, FIG. 2B and FIG. 2C illustrate views for describing a signal processing operation according to various exemplary embodiments of the present invention.

FIG. 3A and FIG. 3B illustrate views for describing an obstacle shape generating process according to various exemplary embodiments of the present invention.

FIG. 4A, FIG. 4B, FIG. 4C, FIG. 4D and FIG. 4E, and FIG. 4F illustrate views for describing an obstacle shape deleting process according to various exemplary embodiments of the present invention.

FIG. 5A, FIG. 5B and FIG. 5C illustrate views for describing an obstacle shape correcting process according to various exemplary embodiments of the present invention.

FIG. 6 illustrates a view for describing a collision risk generating process by use of an obstacle shape according to various exemplary embodiments of the present invention.

FIG. 7 illustrates a flowchart for describing an obstacle shape estimating method according to various exemplary embodiments of the present invention.

FIG. 8 illustrates a detailed flowchart for describing an obstacle shape estimating method according to various exemplary embodiments of the present invention.

FIG. 9 illustrates an example of formation of a single small obstacle in a reverse path of a host vehicle according to various exemplary embodiments of the present invention.

FIG. 10 illustrates an example of formation of a large obstacle in a reverse path of a host vehicle according to various exemplary embodiments of the present invention.

FIG. 11 illustrates an example of formation of a plurality of small obstacles in a reverse path of a host vehicle according to various exemplary embodiments of the present invention.

FIG. 12 illustrates an example of a plurality of small obstacles in a reverse path of a host vehicle according to various exemplary embodiments of the present invention.

FIG. 13 illustrates an example of an obstacle outside a reverse path of a host vehicle according to various exemplary embodiments of the present invention.

FIG. 14 illustrates an example of an obstacle in a narrow parking space according to various exemplary embodiments of the present invention.

FIG. 15 illustrates a computing system according to various exemplary embodiments of the present invention.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, some exemplary embodiments of the present invention will be described in detail with reference to exemplary drawings. It should be noted that in adding reference numerals to constituent elements of each drawing, the same constituent elements have the same reference numerals as possible even though they are indicated on different drawings. Furthermore, in describing exemplary embodiments of the present invention, when it is determined that detailed descriptions of related well-known configurations or functions interfere with understanding of the exemplary embodiments of the present invention, the detailed descriptions thereof will be omitted.

In describing constituent elements according to an exemplary embodiment of the present invention, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally of the present invention of the present invention understood by those skilled in the technical field to which the present invention pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

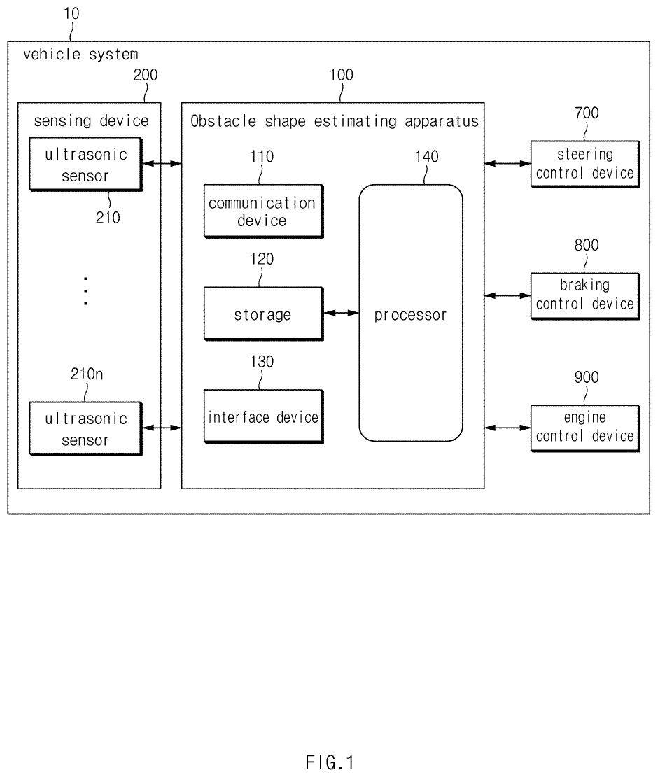

Hereinafter, various exemplary embodiments of the present invention will be described in detail with reference to FIG. 1 to FIG. 15.

FIG. 1 illustrates a block diagram showing a configuration of a vehicle system including an obstacle shape estimating apparatus according to various exemplary embodiments of the present invention.

Referring to FIG. 1, the vehicle system according to the exemplary embodiment of the present invention may include an obstacle shape estimating apparatus 100, a sensing device 200, a steering control device 300, a braking control device 400, and an engine control device 500.

The obstacle shape estimating apparatus 100 according to the exemplary embodiment of the present invention may be implemented inside a vehicle. In the instant case, the obstacle shape estimating apparatus 100 may be integrally formed with internal control units of the vehicle, or may be implemented as a separate device to be connected to control units of the vehicle by a separate connection means.

The obstacle shape estimating apparatus 100 may include a remote smart parking assist (RSPA) system, a smart parking assistant system (SPAS), and the like.

The obstacle shape estimating apparatus 100 may receive a sensing signal from at least one ultrasonic sensor at a predetermined cycle, may generate positions of one or more obstacles according to distance values of an ultrasonic sensor by estimating the distance values of the ultrasonic sensor according to the sensing signal, and may generate obstacle shape information according to positions of remaining obstacles after deleting a position of an obstacle corresponding to a virtual distance value and a position of an obstacle which does not satisfy a validation condition among the positions of the one or more obstacles.

Referring to FIG. 1, the obstacle shape estimating apparatus 100 may include a communication device 110, a storage 120, an interface device 130, and a processor 140.

The communication device 110 is a hardware device implemented with various electronic circuits to transmit and receive signals through a wireless or wired connection, and may transmit and receive information based on in-vehicle devices and in-vehicle network communication techniques. As an example, the in-vehicle network communication techniques may include controller area network (CAN) communication, Local Interconnect Network (LIN) communication, flex-ray communication, and the like.

Furthermore, the communication device 110 may perform communication by use of a server, infrastructure, or third vehicles outside the vehicle, and the like through a wireless Internet technique or short range communication technique. Herein, the wireless Internet technique may include wireless LAN (WLAN), wireless broadband (Wibro), Wi-Fi, Worldwide Interoperability for Microwave Access (WiMAX), etc. Furthermore, short-range communication technique may include Bluetooth, ZigBee, ultra wideband (UWB), radio frequency identification (RFID), infrared data association (IrDA), and the like. For example, the communication device 110 may transmit obstacle shape information generated when an obstacle shape is generated to an in-vehicle control device such as a collision determination device.

The storage 120 may store sensing results of the sensing device 200 and data and/or algorithms required for the processor 140 to operate, and the like.

As an example, the storage 120 may store a parking space search result. In addition, the storage 120 may store information related to an obstacle detected by the sensing device 200, e.g., information related to a shape of an obstacle at the rear when a vehicle is parked.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may include an input means for receiving a control command from a user and an output means for outputting an operation state of the apparatus 100 and results thereof. Herein, the input means may include a key button, and may include a mouse, a joystick, a jog shuttle, a stylus pen, and the like. Furthermore, the input means may further include a soft key implemented on the display.

The interface device 130 may be implemented as a head-up display (HUD), a cluster, an audio video navigation (AVN), a human machine interface (HM), a user setting menu (USM), or the like.

The output means may include a display, and may further include a voice output means such as a speaker. In the instant case, when a touch sensor formed of a touch film, a touch sheet, or a touch pad is provided on the display, the display may operate as a touch screen, and may be implemented in a form in which the input device and the output device are integrated.

The processor 140 may be electrically connected to the communication device 110, the storage 120, the interface device 130, and the like, may electrically control each component, and may be an electrical circuit that executes software commands, performing various data processing and calculations described below.

The processor 140 may process a signal transferred between components of the obstacle shape estimating apparatus 100, and may perform overall control such that each of the components can perform its function normally.

The processor 140 may be implemented in a form of hardware, software, or a combination of hardware and software, or may be implemented as microprocessor, and may be, e.g., an electronic control unit (ECU), a micro controller unit (MCU), or other subcontrollers mounted in the vehicle.

The processor 140 may receive a sensing signal from at least one ultrasonic sensors 210, . . . , and 210n at a predetermined interval in the obstacle shape estimating apparatus.

Furthermore, the processor 140 may estimate the distance value of the ultrasonic sensor based on the sensing signal which is received each predetermined cycle, and may generate positions of one and more obstacles based on the distance value of the ultrasonic sensor. Furthermore, the processor 140 may generate obstacle shape information according to positions of remaining obstacles after deleting a position of an obstacle corresponding to a virtual distance value and a position of an obstacle which does not satisfy a validation condition among the positions of the one or more obstacles. In the instant case, the virtual distance value indicates a distance value by a virtual ultrasonic sensor, and processor 140 may generate the virtual ultrasonic sensor between two adjacent ultrasonic sensors when a distance between the two adjacent ultrasonic sensors is equal to or greater than a predetermined distance. Furthermore, the validation condition may include whether a triangle is formed by use of the distance between two adjacent ultrasonic sensors and distance values of two adjacent ultrasonic sensors.

The processor 140 may estimate distance values of one or more ultrasonic sensors 210, . . . , and 210n by reflecting a travel distance and a travel direction of a host vehicle within a predetermined cycle.

The processor 140 may estimate the virtual distance value of the virtual ultrasonic sensor by use of a distance value of an ultrasonic sensor adjacent to the virtual ultrasonic sensor among the one or more ultrasonic sensors 210, . . . , and 210n.

The processor 140 may determine an obstacle outside a vehicle width among the positions of the one or more obstacles, and may correct the obstacle outside the vehicle width to the outside of the vehicle width.

When a number of one or more obstacles is smaller than and equal to a predetermined number and positions of two adjacent obstacles among positions of the obstacles of which the number is smaller than and equal to the predetermined number are within a predetermined distance, the processor 140 may abbreviate the positions of the two adjacent obstacles to a position of one obstacle.

The processor 140 may perform ultrasonic sensor waveform modeling by use of at least one of a beam angle, a sensitivity, a mounting position, or an angle of one or more ultrasonic sensors.

The processor 140 may generate a start point, a midpoint, and an end point of an ultrasonic sensor waveform as obstacle positions based on the ultrasonic sensor waveform modeling.

The processor 140 may delete a start point, a midpoint, and an end point of a virtual distance waveform based on the virtual distance value.

Furthermore, the processor 140 may determine whether a triangle is formed by use of the distance between two adjacent ultrasonic sensors and distance values of two adjacent ultrasonic sensors to determine whether the validation condition is satisfied.

The processor 140 may delete an obstacle position outside the vehicle width among one or more obstacle positions, and may delete a position of an obstacle which is more than a predetermined distance away from one or more ultrasonic sensors among the one or more obstacle positions.

The processor 140 may delete the start point and the end point when there is the midpoint of the ultrasonic sensor waveform, and may delete a start point and an end point when a predetermined number or more of obstacle positions are generated in a center portion of a bumper of the vehicle.

When at least one of the bumper of the vehicle or one or more obstacle positions is positioned within a predetermined distance, the processor 140 may delete an obstacle position which is within the predetermined distance from the bumper of the vehicle, and may replace it with the obstacle proximity plug.

The processor 140 may determine a possibility of collision by use of obstacle shape information.

The sensing device 200 may detect an obstacle (e.g., a previously parked vehicle, a vehicle moving through a parking lot, etc.), an empty parking space, a parking guide line (parking dividing line), a double-parking guide line, etc. by searching for a parking space. To the present end, the sensing device 200 may include one or more ultrasonic sensors 210, . . . , and 201n. Furthermore, the sensing device 200 may further include various sensors that are necessary for vehicle control, such as a camera, a Light Detection and Ranging (LiDAR), a radar, and a steering angle sensor.

The steering control device 300 may be configured to control a steering angle of a vehicle, and may include a steering wheel, an actuator interlocked with the steering wheel, and a controller configured for controlling the actuator.

The braking control device 400 may be configured to control braking of the vehicle, and may include a controller that is configured to control a brake thereof.

The engine control device 500 may be configured to control engine driving of a vehicle, and may include a controller that is configured to control a speed of the vehicle.

Accordingly, according to various exemplary embodiments of the present invention, it is possible to accurately estimate shapes of obstacles regardless of a speed of a host vehicle, a number of the obstacles, a size thereof, and a position thereof, by removing an undetected area from an area which is detected for each ultrasonic sensor which is received in real time.

Furthermore, according to various exemplary embodiments of the present invention, when a distance between two provided ultrasonic sensors is more than a predetermined distance (for a large vehicle) it is possible to generate a virtual ultrasonic sensor signal and use it to estimate the shapes of the obstacles.

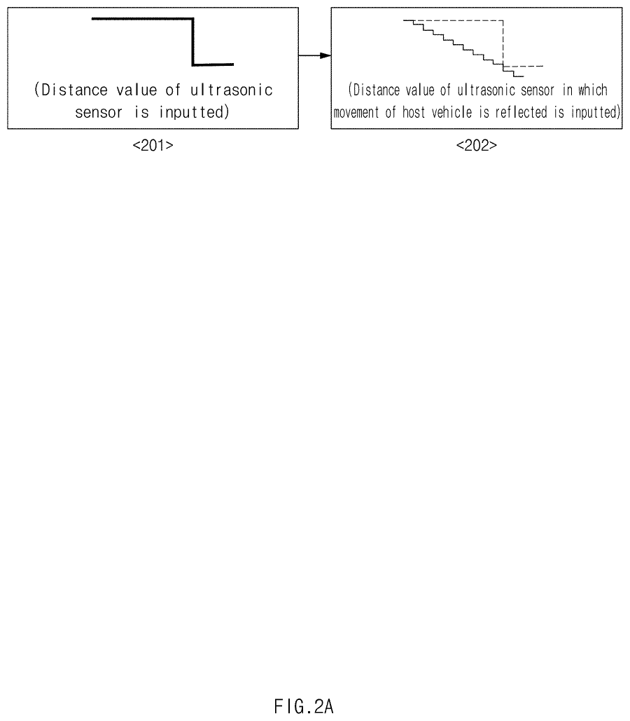

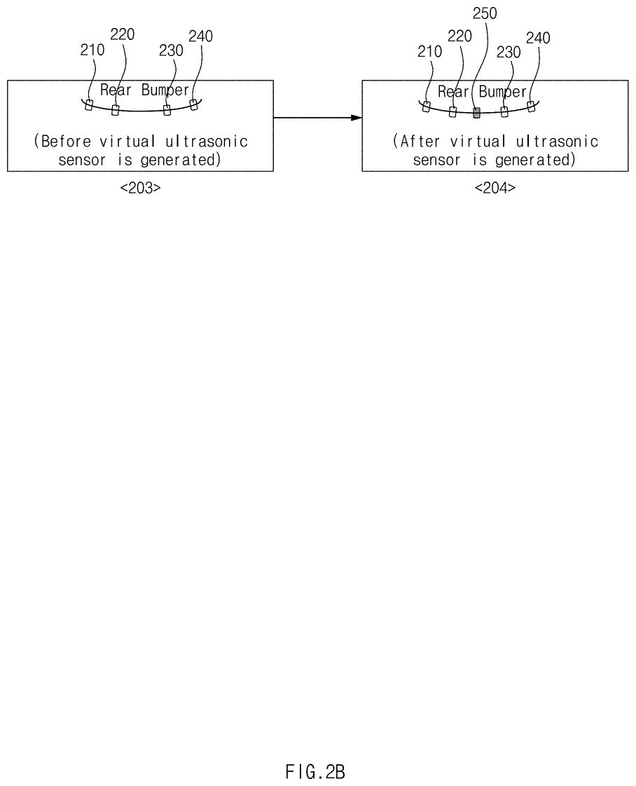

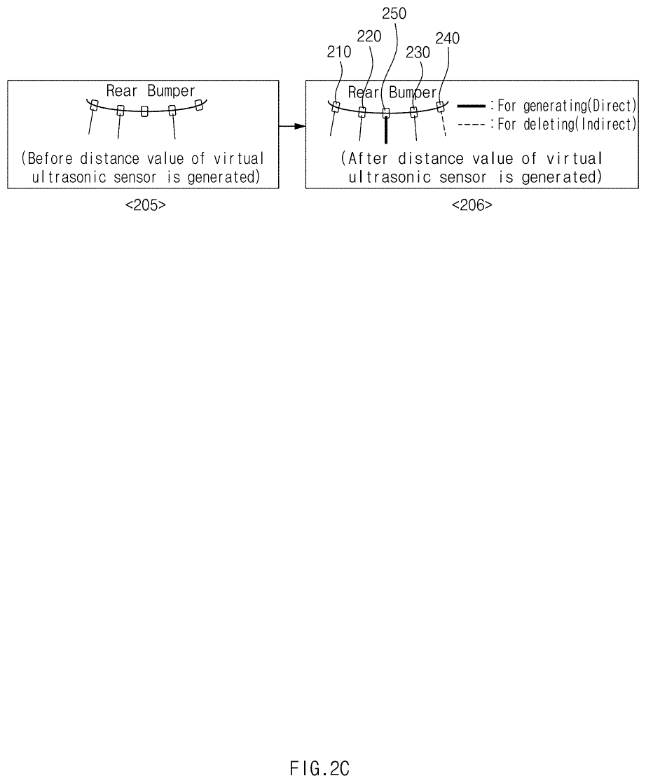

FIG. 2A, FIG. 2B and FIG. 2C illustrate views for describing a signal processing operation according to various exemplary embodiments of the present invention.

The ultrasonic sensors 210, . . . , and 201n perform sensing every predetermined update cycle, and may transmit sensing signals to the obstacle shape estimating apparatus 100. Next, the ultrasonic sensors 210, . . . , and 201n continue to output the previous sensing signals until the next update cycle arrives after transmitting the sensing signals to the obstacle shape estimation apparatus 100.

Accordingly, the obstacle shape estimating apparatus 100 may estimate a distance value of an ultrasonic sensor by reflecting a travel distance and a direction of a host vehicle within the update cycle. Referring to FIG. 2A, an example in which the distance value of the ultrasonic sensor is inputted every update cycle is illustrated, and in a view 202, an example of estimating the distance value of the ultrasonic sensor by reflecting the travel distance and the direction of the host vehicle is illustrated.

Furthermore, when two adjacent ultrasonic sensors mounted on the host vehicle are more than a predetermined distance apart, it may not be accurate to generate obstacle shapes due to a blank area between the two ultrasonic sensors.

Accordingly, the obstacle shape estimating apparatus 100 may generate a virtual ultrasonic sensor by use of two adjacent ultrasonic sensors. In the instant case, the obstacle shape estimating apparatus 100 may generate the virtual ultrasonic sensor in consideration of mounting positions and angles thereof. Referring to FIG. 2B, a view 203 illustrates an example of four ultrasonic sensors 210, 220, 230, and 240 before generating a virtual ultrasonic sensor 250, and a view 204 illustrates an example in which the virtual ultrasonic sensor 250 is generated between the two adjacent ultrasonic sensors 230 and 240.

Accordingly, the obstacle shape estimating apparatus 100 may generate a signal value of the virtual ultrasonic sensor 250 by use of direct and indirect signal values of the two adjacent ultrasonic sensors 230 and 240 even when there is no signal received from the virtual ultrasonic sensor 250.

Referring to FIG. 2C, a view 205 illustrates an example before generation of a signal value (distance value) of the virtual ultrasonic sensor 250, and a view 206 illustrates an example after the generation of the signal value of the virtual ultrasonic sensor 250.

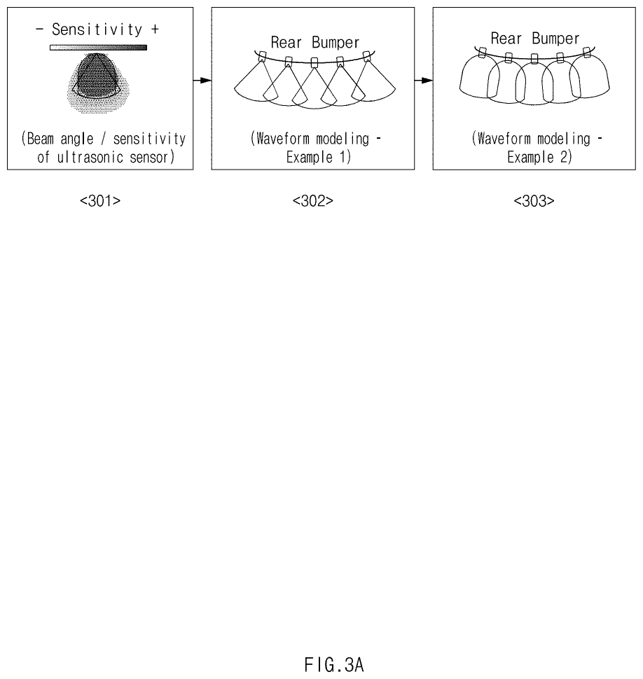

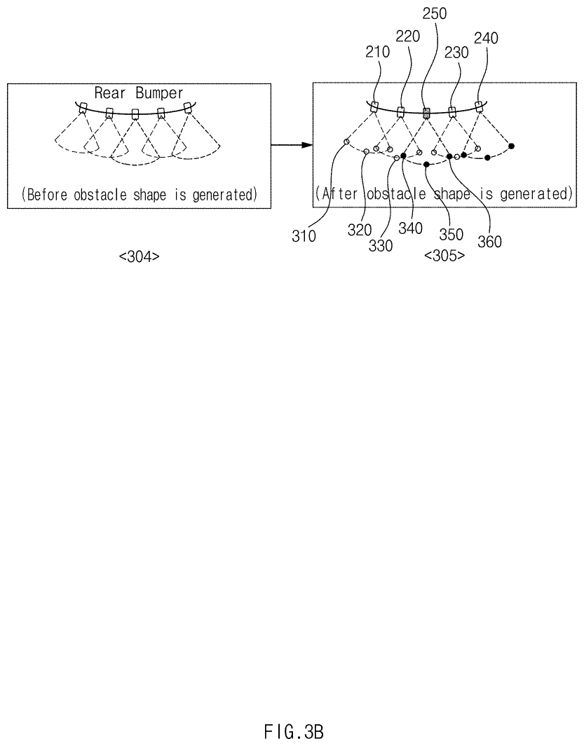

FIG. 3A and FIG. 3B illustrate views for describing an obstacle shape generating process according to various exemplary embodiments of the present invention.

The obstacle shape estimating apparatus 100 may perform waveform modeling depending on a purpose of generating an obstacle shape by use of a beam angle or sensitivity of an ultrasonic sensor, mounting position or mounting angle information, and the like. In the instant case, the beam angle of the ultrasonic sensor may be radial, and reception sensitivity may be adjusted depending on setting of reflected wave reference voltage and may be reflected in the waveform modeling of the ultrasonic sensor.

Referring to FIG. 3A, a view 301 illustrates an example of the beam angle or the sensitivity of the ultrasonic sensor, and views 302 and 303 each illustrate an example of the waveform modeling.

The obstacle shape estimation apparatus 100 generates three obstacle positions of a starting point, a midpoint, and an end point based on a waveform of the ultrasonic sensor. In the instant case, a number of the points indicating the obstacle positions may be changed depending on the purpose of generating the obstacle shape. Furthermore, the obstacle positions and a virtual distance value generated by the received distance value of the ultrasonic sensor should be distinguished.

Referring to FIG. 3B, a view 304 illustrates an example before generating an obstacle shape, and a view 305 illustrates an example after generating a starting point 310, a midpoint 320, and an end point 330 of an obstacle position. In the instant case, for convenience of description, the obstacle positions 310, 320, and 330 by the real ultrasonic sensor 210 and obstacle positions 340, 350, and 360 by the virtual ultrasonic sensor 230 are separately marked.

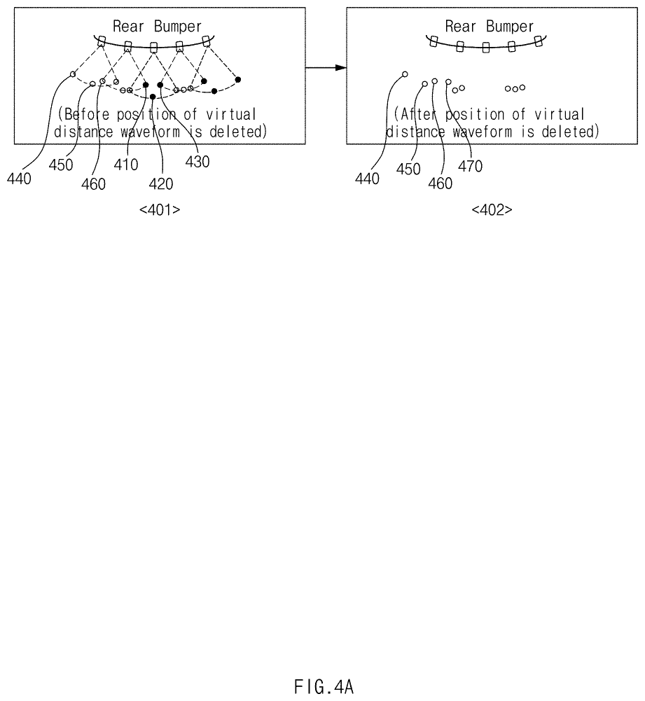

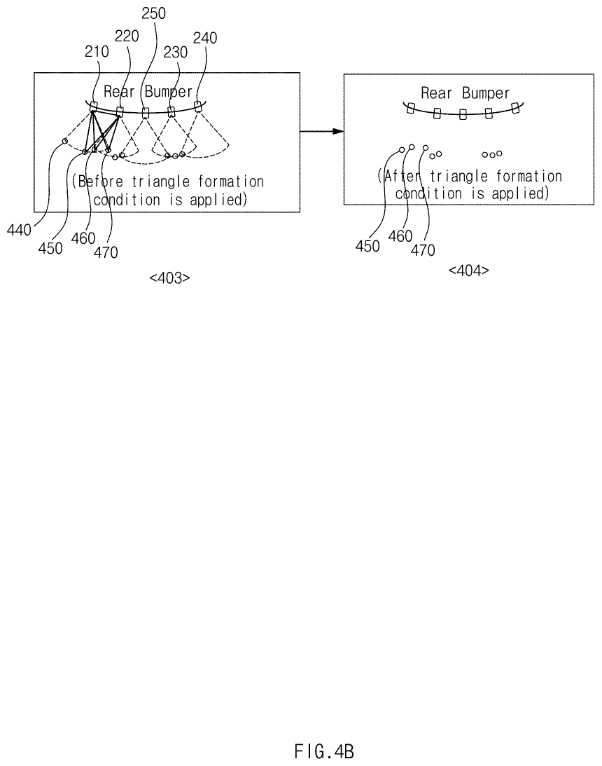

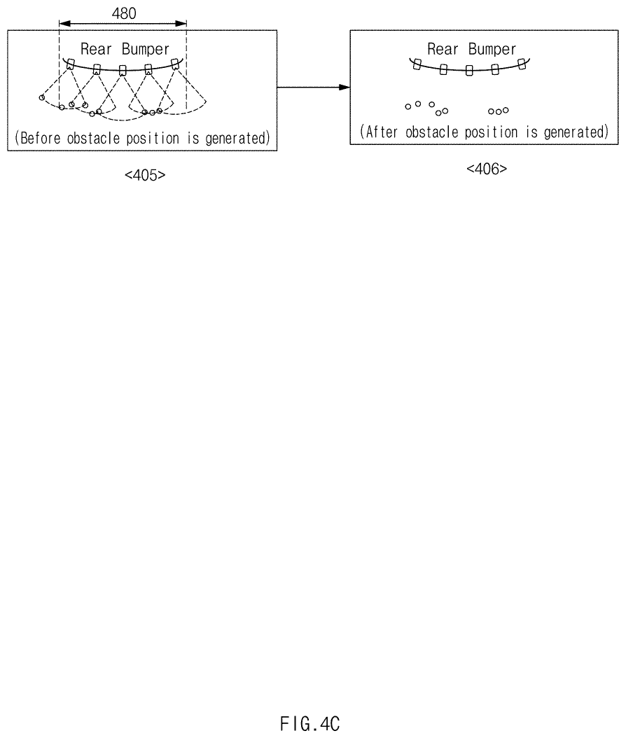

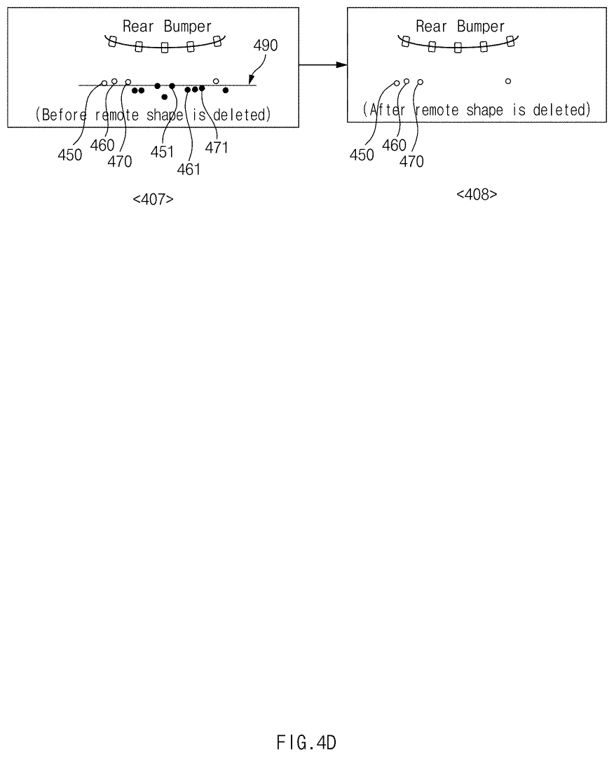

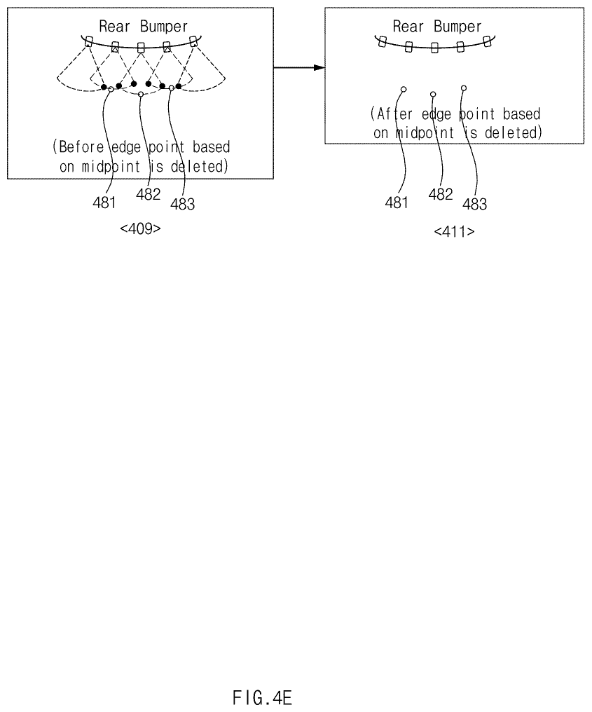

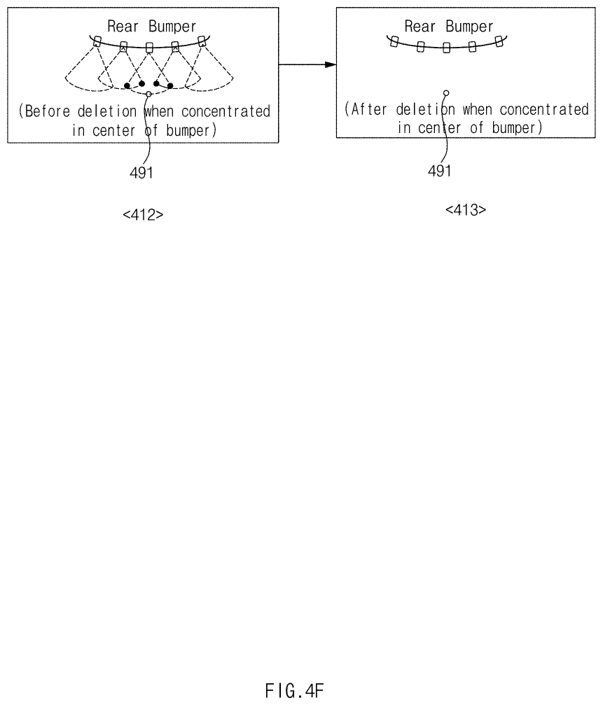

FIG. 4A to FIG. 4F illustrate views for describing a process of deleting an obstacle shape according to various exemplary embodiments of the present invention.

The obstacle shape estimating apparatus 100 may delete obstacle position information for an area in which it is determined that there is no obstacle by use of a virtual distance waveform. Referring to FIG. 4A, a view 401 illustrates an example before deleting a position of the virtual distance waveform, and a view of 402 illustrates an example after deleting positions 410, 420, and 430 of the virtual distance waveform.

The obstacle shape estimating device 100 checks a triangle formation condition by use of a distance between the two adjacent ultrasonic sensors 210 and 220 and direct and indirect signals of the two ultrasonic sensors. The obstacle shape estimating apparatus 100 may utilize indirect information for a purpose, and may delete information related to an obstacle position 440 outside a valid triangle. A view 403 in FIG. 4B illustrates an example before applying the triangle formation condition, and a view 494 illustrates an example after applying the triangle formation condition. In the view 404, it may be seen that the obstacle position 440 outside the triangle is deleted.

Furthermore, the obstacle shape estimating apparatus 100 may delete obstacle position information outside the vehicle width depending on a purpose of estimating the obstacle shape. A view 405 of FIG. 4C illustrates an example in which an obstacle position outside a vehicle width 480 is marked, and a view 406 illustrates an example in which the obstacle position outside the vehicle width is deleted. That is, the obstacle position outside the vehicle width may be deleted in the obstacle shape estimation for parking collision prevention.

In the meantime, reliability may be different for each sensing distance of the ultrasonic sensor, and the longer the distance, the lower the reliability. Using this, the obstacle shape estimating apparatus 100 may delete obstacles 451, 461, and 471 including a predetermined longitudinal distance 490 or more based on a bumper.

A view 407 in FIG. 4D illustrates an example before deleting a remote shape, and a view 408 illustrates an example after deleting the remote shape.

The obstacle shape estimating apparatus 100 may delete a start point and an end point when midpoints 481, 482, and 483 remain based on an individual ultrasonic sensor waveform. The obstacle shape estimating apparatus 100 may delete the start point and the end point in the obstacle shape estimation for parking collision prevention.

A view 409 of FIG. 4E illustrates an example before deleting an edge point based on a midpoint, and a view 411 illustrates an example after deleting the edge point based on the midpoint.

The obstacle shape estimating apparatus 100 may delete a start point and an end point based on an individual ultrasonic sensor waveform when there are more than a predetermined number of obstacle positions in a center portion of a bumper.

A view 412 of FIG. 4F illustrates an example before deleting the start point and the end point based on a midpoint 491 when the obstacle position is concentrated in the center portion of the bumper, and a view 413 illustrates an example in which only the intermediate point 491 remains by deleting the start point and the end point when the obstacle position is concentrated in the center portion of the bumper.

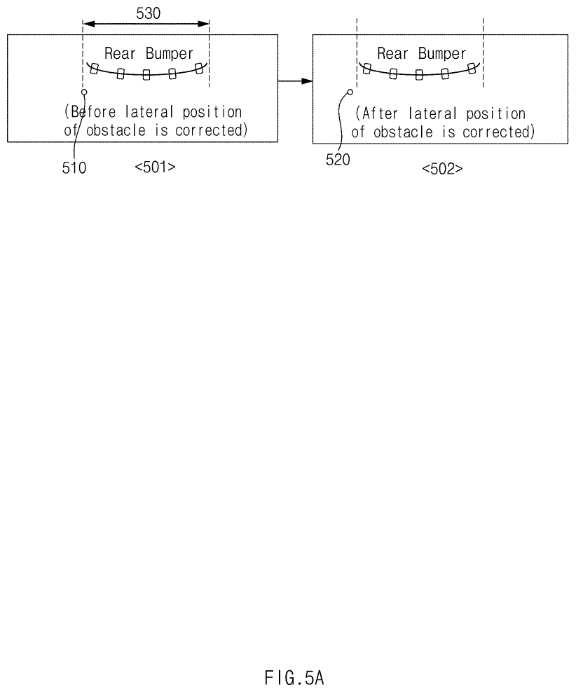

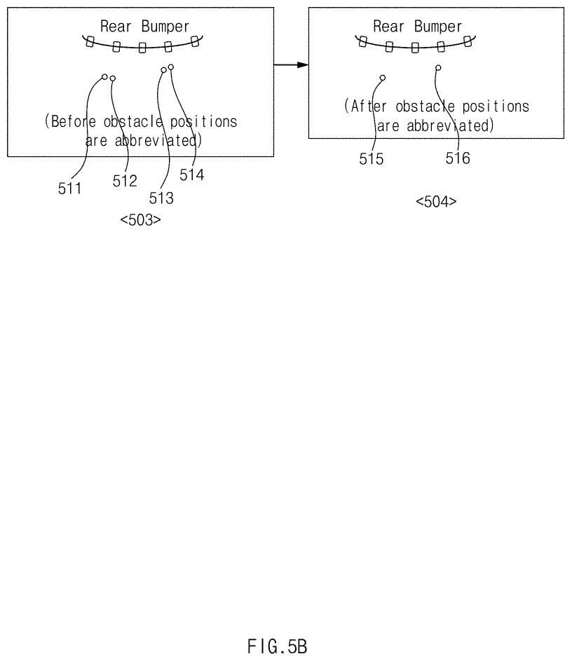

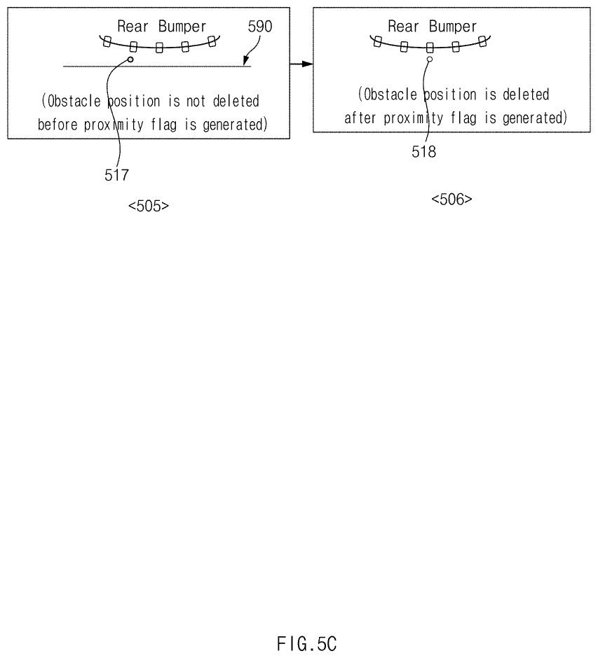

FIG. 5A to FIG. 5C illustrate views for describing an obstacle shape correcting process according to various exemplary embodiments of the present invention.

The obstacle shape estimation apparatus 100 may correct an obstacle outside the vehicle width 530. That is, the obstacle shape estimating apparatus 100 may perform correction when an indirect signal is long over a predetermined distance by use of the direct and indirect signals of ultrasonic sensors at rear left and right sides. The obstacle shape estimating apparatus 100 may correct a lateral position to an outside of the vehicle width in the obstacle shape estimation for parking collision prevention.

A view 501 of FIG. 5A illustrates an example before correcting the lateral position of an obstacle 510, and a view 502 illustrates an example after correcting the lateral position of the obstacle.

When a predetermined number of obstacle positions remain, the obstacle shape estimation apparatus 100 may abbreviate them depending on positions. A difference between lateral positions of two adjacent obstacles 511 and 512 approaching each other among 5 or less of obstacles, which is within a predetermined distance, may be abbreviated in the obstacle shape estimation for parking collision prevention.

A view 503 of FIG. 5A illustrates an example before abbreviating the lateral positions of the two obstacles 511 and 512, which approach each other within a predetermined distance, and lateral positions of obstacles 513 and 514.

A view 504 illustrates an example in which the lateral positions of the two obstacles 511 and 512 approaching each other within a predetermined distance are abbreviated to a single obstacle 515, and lateral positions of the two obstacles 513 and 514 are abbreviated to a single obstacle 516.

An obstacle shape estimating apparatus 100 may delete obstacle position information, and may replace it with an obstacle proximity flag when a lateral distance between the bumper and the obstacle shape is within a predetermined distance 590. That is, the obstacle shape estimating apparatus 100 may replace it with a proximity flag in the obstacle shape estimation for parking collision prevention.

505 of FIG. 5C illustrates an example in which an obstacle position 517 including a lateral position which is within the predetermined distance 590 is not deleted before a proximity flag is generated, and a view 506 illustrates an example in which the obstacle position 517 including the lateral position which is within the predetermined distance 590 is deleted.

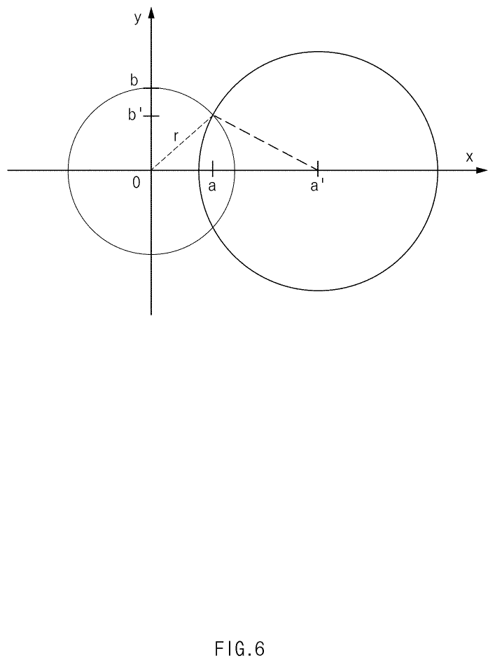

FIG. 6 illustrates a view for describing a collision risk generating process by use of an obstacle shape according to various exemplary embodiments of the present invention.

The obstacle shape estimating apparatus 100 may store obstacle shape information generated as described above, and may provide the obstacle shape information to an in-vehicle control device. For example, the collision determination control apparatus may use the received obstacle shape information to determine a collision possibility of the vehicle and warn a driver by providing the obstacle shape information to a collision determination control device among in-vehicle control devices, and may determine an emergency braking condition and perform a braking request.

Referring to FIG. 6, an intersection point of two circles is positioned on one the two circles, and when x=0, then r=y, and when x≠0, then r>y, in an equation x²+y²=r². When estimating an obstacle shape, an ultrasonic sensor waveform may be modeled to indicate the shape of an obstacle in a form of a starting point, a midpoint, and an end point, and the midpoint remains after a shape correction process, and thus it may be formed farther than the intersection point.

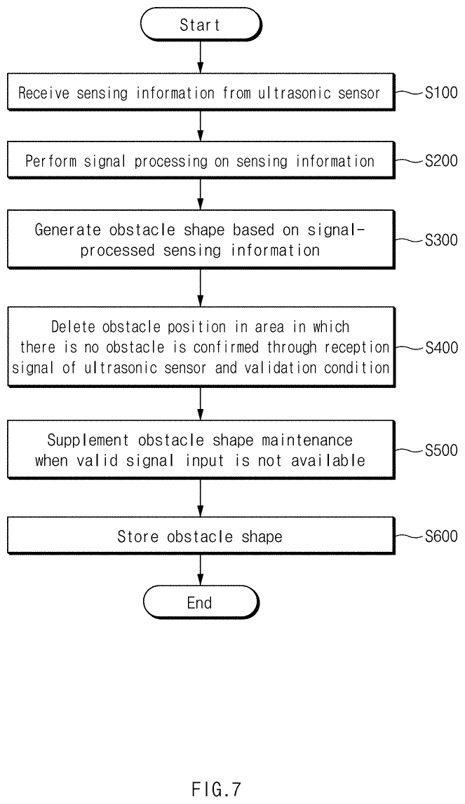

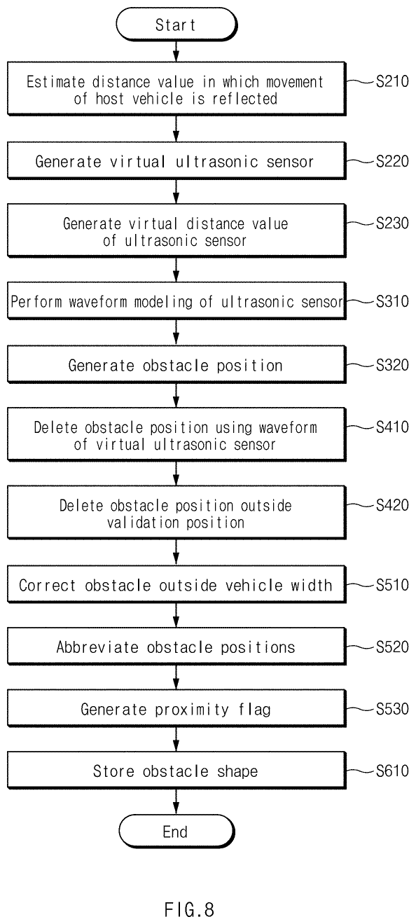

Hereinafter, an obstacle shape estimating method according to various exemplary embodiments of the present invention will be described in detail with reference to FIG. 7. FIG. 7 illustrates a flowchart for describing an obstacle shape estimating method according to various exemplary embodiments of the present invention, and FIG. 8 illustrates a detailed flowchart for describing an obstacle shape estimating method according to various exemplary embodiments of the present invention.

Hereinafter, it is assumed that the obstacle shape estimating apparatus 100 of FIG. 1 performs the processes of FIG. 7 and FIG. 8. Furthermore, in the description of FIG. 7 and FIG. 8, operations referred to as being performed by the device may be understood as being controlled by the processor 140 of the obstacle shape estimating apparatus 100.

Referring to FIG. 7, the obstacle shape estimating apparatus 100 may receive sensing information from the ultrasonic sensors 210, . . . , and 210n (S100).

Accordingly, the obstacle shape estimating apparatus 100 performs signal processing of the received sensing information (S200).

Thereafter, the obstacle shape estimating apparatus 100 may generate an obstacle shape based on the signal-processed sensing information (S300).

The obstacle shape estimating apparatus 100 deletes the obstacle position in an area in which there no obstacle is confirmed through a reception signal of the ultrasonic sensor and a validation condition (S400).

The obstacle shape estimating apparatus 100 supplements obstacle shape maintenance when a valid signal input is not available (S500).

The obstacle shape estimating apparatus 100 stores the generated obstacle shape (S600).

FIG. 8 illustrates each step of FIG. 7 in detail.

Referring to FIG. 8, when a distance value of an ultrasonic sensor is received from the ultrasonic sensor, obstacle shape estimation is started.

The obstacle shape estimating apparatus 100 estimates the distance value of the ultrasonic sensor by reflecting a travel distance and a direction of a host vehicle within a sensing signal update cycle of the ultrasonic sensor (S210). Next, when two adjacent ultrasonic sensors mounted on the host vehicle are a predetermined distance apart, a virtual ultrasonic sensor is generated in a blank area between the two ultrasonic sensors (S220).

The obstacle shape estimating apparatus 100 generates a virtual distance value of the ultrasonic sensor (S230). That is, when no signal is received, the obstacle shape estimating apparatus 100 may generate the virtual distance value of the ultrasonic sensor (e.g., a virtual ultrasonic sensor) without a received signal by use of a signal value of an adjacent ultrasonic sensor.

The obstacle shape estimating apparatus 100 performs waveform modeling for generating an obstacle shape using a beam angle, a sensitivity, a mounting position, a mounting angle, etc. of the ultrasonic sensor (S310).

Next, the obstacle shape estimating apparatus 100 generates three obstacle positions, such as a start point, a midpoint, and an end point, from a waveform of the ultrasonic sensor based on a result of the waveform modeling result (S320). In the instant case, the distance value by the virtual ultrasonic sensor and the distance value by the real ultrasonic sensor are distinguished.

The obstacle shape estimating apparatus 100 deletes obstacle position information for an area in which it is determined that there is no obstacle by use of a waveform of the virtual ultrasonic sensor (S410).

Furthermore, the obstacle shape estimating device 100 may check a triangle formation condition (validation position) by use of a distance between two adjacent ultrasonic sensors 210 and 220 and signals of the two ultrasonic sensors, and may delete position information of an obstacle outside the valid triangle (S420).

Furthermore, the obstacle shape estimating apparatus 100 may delete an obstacle position outside a vehicle width, an obstacle position over a predetermined distance from a bumper, the starting point and the ending point when the midpoint remains based on the waveform of the individual ultrasonic sensor, and the start point and the end point based on the waveform of the individual ultrasonic sensor when more than a predetermined number of obstacle positions exist in a center portion of the bumper.

Next, the obstacle shape estimating apparatus 100 may determine an obstacle outside the vehicle width, and may correct a lateral position of the obstacle to an outside of the vehicle width by use of signal values of ultrasonic sensors at rear left and right sides (S510).

In the case where a predetermined number of obstacle positions remain, when a difference between lateral positions of two adjacent obstacles is within a predetermined distance, the obstacle shape estimating apparatus 100 may abbreviate them to one obstacle position (S520).

The obstacle shape estimating apparatus 100 may delete obstacle position information, and may replace it with an obstacle proximity flag when a lateral distance between the bumper and the obstacle shape is within a predetermined distance (S530).

The obstacle shape estimating apparatus 100 may store the generated obstacle shape (S610).

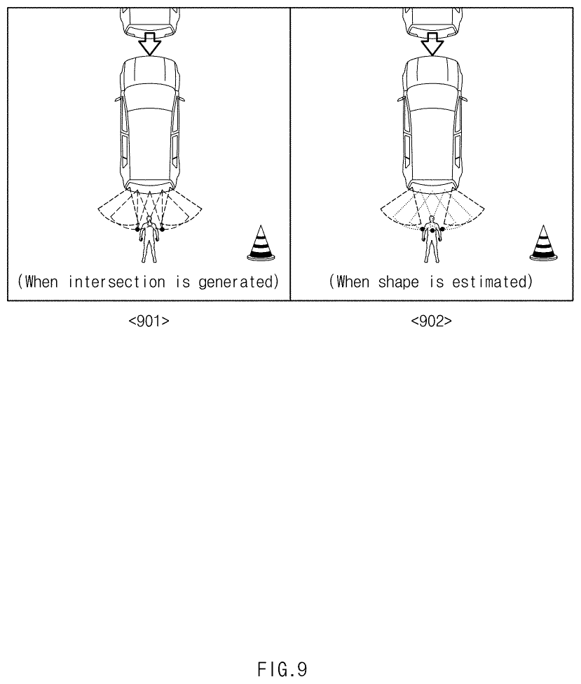

FIG. 9 illustrates an example of formation of a single small obstacle in a reverse path of a host vehicle according to various exemplary embodiments of the present invention.

Referring to FIG. 9, when a small obstacle (e.g., a pedestrian or a parking cone) exists in a reverse path of a host vehicle, a shape and a position of the obstacle may be estimated by generating an intersection.

However, when an intersection is generated by use of values of rear center left and right ultrasonic sensors as illustrated in a view 901, a width of the pedestrian cannot be accurately estimated, and the pedestrian in the center portion cannot be estimated.

Accordingly, the obstacle shape estimating apparatus 100 according to various exemplary embodiments of the present invention may estimate the pedestrian width by deleting an undetected waveform area using the values of the rear left and right ultrasonic sensors as illustrated in a view 902. Furthermore, the obstacle shape estimating apparatus 100 may generate a virtual ultrasonic sensor in a center portion between the rear left and right ultrasonic sensors to accurately estimate a shape of the pedestrian positioned in the center.

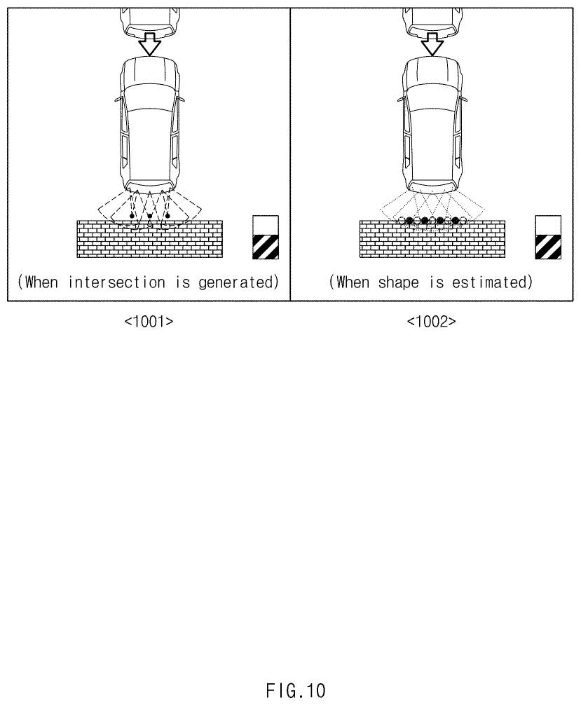

FIG. 10 illustrates an example of formation of a single large obstacle in a reverse path of a host vehicle according to various exemplary embodiments of the present invention.

Referring to FIG. 10, when a large obstacle (e.g., a wall, a column, etc.) exists in a reverse path of a host vehicle, a shape and a position of the obstacle may be estimated by generating an intersection.

As illustrated in a view 1001, when an intersection is generated using four rear ultrasonic sensors, a lateral distance of a wall behind the bumper is generated close, and an actual width of the wall may not be estimated.

Accordingly, the obstacle shape estimating apparatus 100 according to various exemplary embodiments of the present invention may generate a virtual ultrasonic sensor in a center portion between rear left and right ultrasonic sensors as illustrated in 1002 to estimate an actual lateral distance of the wall behind the bumper by use of a total of 5 ultrasonic sensors and to estimate a width of the wall to be similar to the vehicle width.

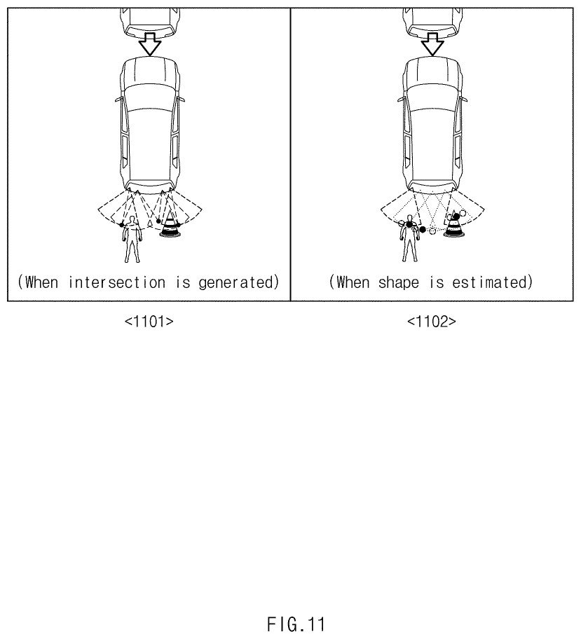

FIG. 11 illustrates an example of formation of a plurality of small obstacles in a reverse path of a host vehicle according to various exemplary embodiments of the present invention.

Referring to FIG. 11, when a plurality of small obstacles (e.g., pedestrians, parking cones, etc.) exist in a reverse path of a host vehicle, an intersection is generated by use of rear four ultrasonic sensors as illustrated in a view 1101, and thus three obstacle positions are generated in close proximity to the pedestrians or parking cones, widths of the pedestrians or parking cones may not be estimated.

Accordingly, the obstacle shape estimating apparatus 100 according to various exemplary embodiments of the present invention may generate a virtual ultrasonic sensor in a center portion between rear left and right ultrasonic sensors as illustrated in 1102 to estimate the width of the pedestrians or parking cones by generating final three obstacle positions close to the pedestrians or parking cones using a total of 5 ultrasonic sensors.

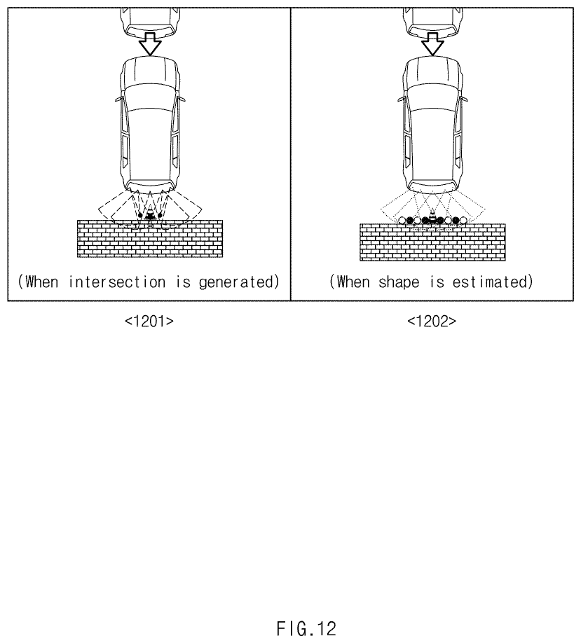

FIG. 12 illustrates an example of a plurality of small obstacles in a reverse path of a host vehicle according to various exemplary embodiments of the present invention.

Referring to FIG. 12, in the case where a plurality of obstacles (walls, pillars, pedestrians, parking cones, etc.) in which a large obstacle and a small obstacle are mixed exist in a reverse path of a host vehicle, when an intersection is generated by use of rear four ultrasonic sensors as illustrated in a view 1201, a lateral distance of a parking cone in front of a wall behind a bumper is generated close, and an actual width of the wall may not be estimated.

Accordingly, the obstacle shape estimating apparatus 100 according to various exemplary embodiments of the present invention may generate a virtual ultrasonic sensor in a center portion between rear left and right ultrasonic sensors as illustrated in 1202 to estimate an actual lateral distance of a parking cone in front of the wall behind the bumper through 5 ultrasonic sensors and to estimate a width of the wall to be similar to the vehicle width.

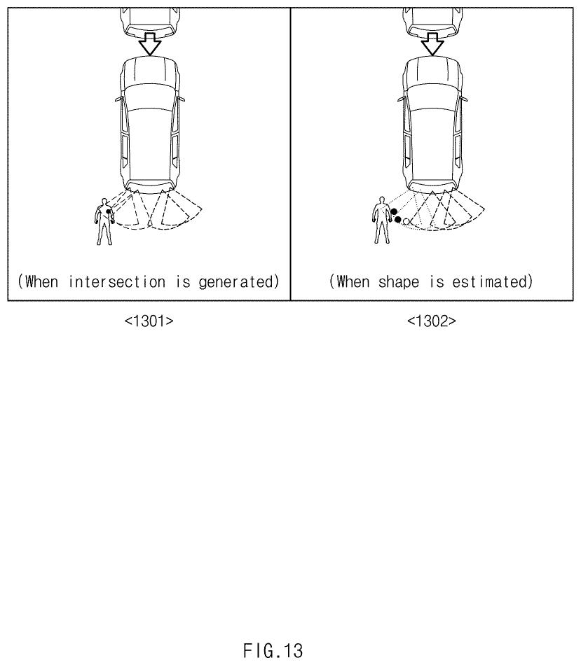

FIG. 13 illustrates an example of an obstacle outside a reverse path of a host vehicle according to various exemplary embodiments of the present invention.

Referring to FIG. 13, in the case where a pedestrian or a parking cone exists outside a reverse path of a host vehicle, when an intersection is generated by use of rear four ultrasonic sensors as illustrated in a view 1201, an obstacle outside a vehicle width is mainly generated outside the vehicle width. Accordingly, the obstacle shape estimating apparatus 100 according to various exemplary embodiments of the present invention determines an obstacle outside the vehicle width as illustrated in a view 1302 and corrects a position of an obstacle generated within the vehicle width by moving it to an outside of the vehicle width.

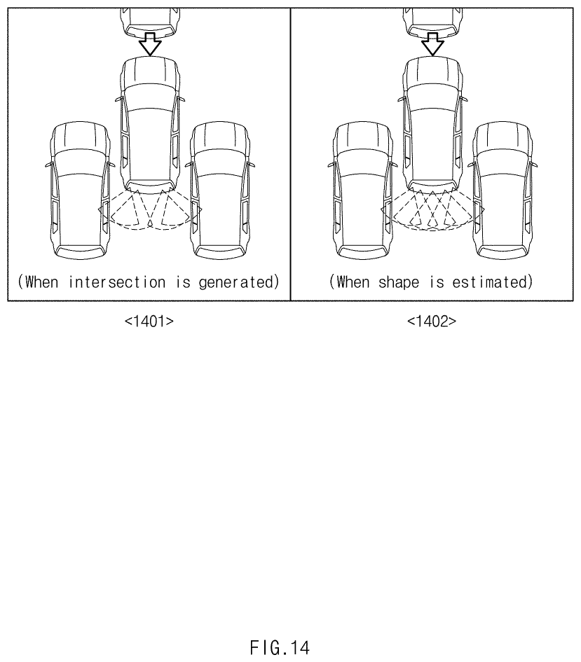

FIG. 14 illustrates an example of an obstacle in a narrow parking space according to various exemplary embodiments of the present invention.

Referring to FIG. 14, when a parking space is narrow, an intersection may not be generated by determining it as a narrow parking space situation using a combination of signals of the ultrasonic sensors as illustrated in a view 1401.

Accordingly, the obstacle shape estimating apparatus 100 according to various exemplary embodiments of the present invention may not perform obstacle shape estimation by determining it as the narrow parking space situation using a combination of the signals of the ultrasonic sensors as illustrated in a view 1402.

Accordingly, according to various exemplary embodiments of the present invention, it is possible to improve obstacle position accuracy by estimating a shape of a target obstacle for preventing parking collision between the host vehicle and the obstacle.

Furthermore, according to various exemplary embodiments of the present invention, the distance value may be estimated by reflecting a movement of the host vehicle to an ultrasonic sensor signal updated every cycle, and when a distance between the ultrasonic sensors mounted in the vehicle is greater than a predetermined distance, a virtual ultrasonic sensor may be generated to estimate the distance value.

According to various exemplary embodiments of the present invention, in the case of a large obstacle (a wall, a column, etc.), when an intersection is generated, a limitation of generating it closer than an actual lateral distance to the bumper may be solved through shape estimation, and a problem of pre-braking to avoid an obstacle may also be solved by applying it to parking collision prevention.

According to various exemplary embodiments of the present invention, in the case of a small obstacle (a pedestrian, a parking cone, etc.) when an intersection is generated, a limitation of generating it only at an unspecified position may be solved through shape estimation, and obstacle avoidance may be performed through steering control based on shape information of the obstacle.

Furthermore, according to various exemplary embodiments of the present invention, when UX (HMI) is applied, an obstacle shape may be marked instead of displaying only a warning, increasing awareness of a user.

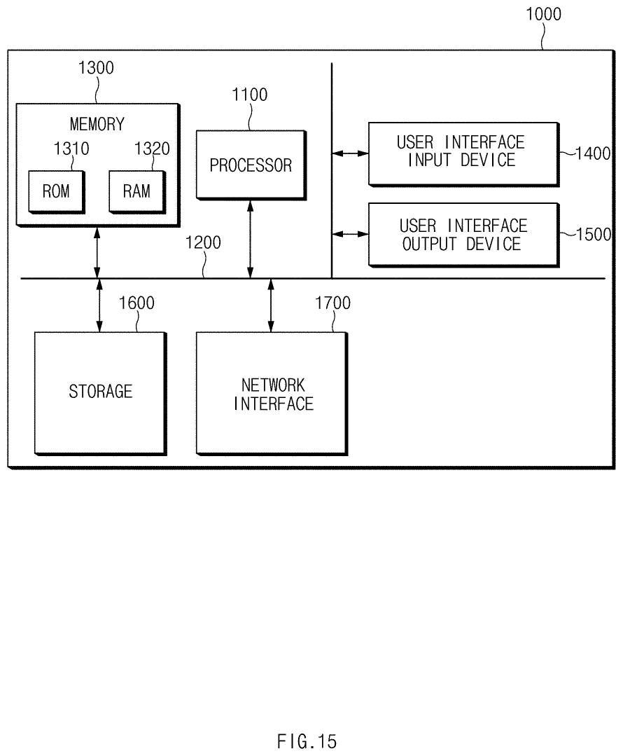

FIG. 15 illustrates a computing system according to various exemplary embodiments of the present invention.

Referring to FIG. 15, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, a EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present invention, and those skilled in the art to which various exemplary embodiments of the present invention pertains may make various modifications and variations without departing from the essential characteristics of the present invention.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An obstacle shape estimating apparatus, comprising:
a processor configured to receive a sensing signal from at least one ultrasonic sensor at a predetermined cycle, to generate positions of one or more obstacles according to distance values of an ultrasonic sensor by estimating the distance values of the ultrasonic sensor according to the sensing signal, and to generate obstacle shape information according to positions of remaining obstacles after deleting a position of an obstacle corresponding to a virtual distance value and a position of an obstacle which does not satisfy a validation condition among the positions of the one or more obstacles; and
a storage configured to store data and an algorithm driven by the processor, and the obstacle shape information generated by the processor.

2. The obstacle shape estimating apparatus of claim 1, wherein the processor is configured to determine an obstacle outside a vehicle width among the positions of the one or more obstacles, and to correct the obstacle outside the vehicle width to an outside of the vehicle width.

3. The obstacle shape estimating apparatus of claim 1, wherein when a number of the one or more obstacles is smaller than and equal to a predetermined number and positions of two adjacent obstacles among positions of the obstacles of which the number is smaller than and equal to the predetermined number are within a predetermined distance, the processor is configured to abbreviate the positions of the two adjacent obstacles to a position of one obstacle.

4. The obstacle shape estimating apparatus of claim 1, wherein the processor is configured to estimate distance values of the one or more ultrasonic sensors by reflecting a travel distance and a travel direction of a host vehicle within the predetermined cycle.

5. The obstacle shape estimating apparatus of claim 1, wherein the processor is configured to generate a virtual ultrasonic sensor between two adjacent ultrasonic sensors when a distance between the two adjacent ultrasonic sensors is equal to or greater than a predetermined distance.

6. The obstacle shape estimating apparatus of claim 5, wherein the processor is configured to estimate a virtual distance value of the virtual ultrasonic sensor by use of a distance value of an ultrasonic sensor adjacent to the virtual ultrasonic sensor among the one or more ultrasonic sensors.

7. The obstacle shape estimating apparatus of claim 6, wherein the processor is configured to perform ultrasonic sensor waveform modeling by use of at least one of a beam angle, a sensitivity, a mounting position, or an angle of the one or more ultrasonic sensors.

8. The obstacle shape estimating apparatus of claim 7, wherein the processor is configured to generate a start point, a midpoint, and an end point of an ultrasonic sensor waveform as obstacle positions based on the ultrasonic sensor waveform modeling.

9. The obstacle shape estimating apparatus of claim 8, wherein the processor is configured to delete a start point, a midpoint, and an end point of a virtual distance waveform based on the virtual distance value.

10. The obstacle shape estimating apparatus of claim 1, wherein the processor is configured to determine whether a triangle is formed by use of a distance between two adjacent ultrasonic sensors and distance values of the two adjacent ultrasonic sensors to determine whether the validation condition is satisfied.

11. The obstacle shape estimating apparatus of claim 1, wherein the processor is configured to delete a position of an obstacle outside a vehicle width from among the positions of the one or more obstacles.

12. The obstacle shape estimating apparatus of claim 1, wherein the processor is configured to delete a position of an obstacle which is more than a predetermined distance away from among the one or more obstacle positions.

13. The obstacle shape estimating apparatus of claim 8, wherein the processor is configured to delete the start point and the end point when there is the midpoint of the ultrasonic sensor waveform.

14. The obstacle shape estimating apparatus of claim 8, wherein the processor is configured to delete the start point and the end point when a predetermined number or more of obstacle positions are generated in a center portion of a bumper of a vehicle.

15. The obstacle shape estimating apparatus of claim 1, wherein when at least one of a bumper of a vehicle or one or more obstacle positions is positioned within a predetermined distance, the processor is configured to delete an obstacle position which is within the predetermined distance from the bumper of the vehicle, and to replace the obstacle position with an obstacle proximity plug.

16. The obstacle shape estimating apparatus of claim 1, wherein the processor is configured to determine a possibility of collision by use of the obstacle shape information.

17. An obstacle shape estimating method comprising:
receiving, by a processor, a sensing signal from one or more ultrasonic sensors every predetermined cycle;
estimating, by the processor, a distance value of an ultrasonic sensor based on the sensing signal;
generating, by the processor, one or more obstacle positions based on the distance value of the ultrasonic sensor;
deleting, by the processor, a position of an obstacle corresponding to a virtual distance value and a position of an obstacle which does not satisfy a validation condition among the positions of the one or more obstacles; and
generating, by the processor, obstacle shape information according to positions of remaining obstacles after the deleting.

18. The obstacle shape estimating method of claim 17, wherein the estimating of the distance value of the ultrasonic sensor includes estimating distance values of the one or more ultrasonic sensors by reflecting a travel distance and a travel direction of a host vehicle within the predetermined cycle.

19. The obstacle shape estimating method of claim 17, wherein the deleting of the positions of the obstacles, when a number of the one or more obstacles is smaller than and equal to a predetermined number and positions of two adjacent obstacles among positions of the obstacles of which the number is smaller than and equal to the predetermined number are within a predetermined distance, includes abbreviating the positions of the two adjacent obstacles to a position of one obstacle.

20. The obstacle shape estimating method of claim 17, further including:
generating a virtual ultrasonic sensor between two adjacent ultrasonic sensors when a distance between the two adjacent ultrasonic sensors is equal to or greater than a predetermined distance.
